(19) United States
(12) Patent Application Publication
(10) Pub. No.: US 2009/0181131 A1
(43) Pub. Date: Jul. 16, 2009

(54) MEAL PREPARATION SYSTEM AND METHODS

(76) Inventor: Victoria D. Forbes-Roberts, Minneapolis, MN (US)

Correspondence Address: MERCHANT & GOULD PC, P.O. BOX 2903, MINNEAPOLIS, MN, 55402-0903, US

(21) Appl. No.: 12/351,625

(22) Filed: Jan. 9, 2009

Related U.S. Application Data
(60) Provisional application No. 61/020,589, filed on Jan. 11, 2008.

(51) Int. Cl. A23L 1/48; G06Q 30/00; G06Q 50/00

(52) U.S. Cl. 426/106; 426/392; 705/26; 705/15

(57) ABSTRACT

A meal kit includes multiple food dishes disposed in a transport medium where each food dish includes a plurality of containers having ingredients in a prepared state. The meal kit further includes planning instructions that provide the cooking order for each food dish. A method for ordering a meal kit includes providing a plurality of food dish options and generating a kit assembly packet based on selected food dish options. A method for assembling a meal kit includes packaging each of a plurality of food dishes having ingredients in a ready-to-cook/assemble state and planning instructions in a transport medium.

### CROSS REFERENCE TO RELATED APPLICATION

The present application claims priority to U.S. Provisional Patent Application Ser. No. 61/020,589, filed on Jan. 11, 2008, entitled “Meal Preparation System and Methods,” and having Attorney Docket No. 15884.0001USP1. The above identified disclosure is hereby incorporated by reference in its entirety.

### BACKGROUND

Consumers today live in a fast paced society. In such a society, consumers often do not have either the time or the energy to create meal plans or to prepare meals from scratch ingredients. In order to plan/prepare meals, the consumer must find suitable recipes from sources such as cookbooks, get ingredients for that recipe from grocery stores, prepare those ingredients for cooking, and cook those ingredients. As all of these activities require a considerable amount of time, consumers' reliance upon fast food products for their meals has grown.

However, such a reliance on these types of food products has contributed to a rising problem of obesity in consumers. In order to counter the effects of obesity, consumers are urged to exercise and make healthier meal choices. However, as previously described, healthier meal choices require both time and energy. Therefore, there is a need in today's fast paced society for a healthy meal that is easy to plan and prepare.

### SUMMARY

An aspect of the present disclosure relates to a meal kit having multiple food dishes disposed in a transport medium. Each food dish includes a plurality of containers having ingredients in a prepared state. In another aspect of the present disclosure, the meal kit further includes planning instructions that provide the cooking order for each food dish.

Another aspect of the present disclosure relates to a meal kit having a plurality of food dishes disposed in a transport medium. Each food dish includes a plurality of containers having distinct markers associate therewith. The plurality of containers includes a plurality of ingredients in a prepared state. The meal kit further includes a plurality of preparation instructions. Each of the plurality of preparation instructions provides for the preparation of one of the plurality of food dishes. Each of the plurality of preparation instructions refers to the containers of each food dish by the distinct markers and indicates an order in which each container of each food dish is to be prepared.

Another aspect of the present disclosure relates to a method for receiving an order for a meal kit. The method includes providing a remote device with a plurality of food dish options. Each of the food dish options represents a food dish that must be prepared by a consumer from a plurality of ingredients disposed in containers in a prepared state that are provided to the consumer. The method further includes receiving food dish selections from the remote device. Additional food dish suggestions to the remote device based on the selected food dish. A kit assembly packet is generated based on received food dish selections. The kit assembly packet includes preparation instructions for the preparation of the selected food dish. The preparation instructions refer to the containers of the selected food dish by distinct markers disposed on each of the containers and indicate an order in which each container of the selected food dish is to be prepared.

Another aspect of the present disclosure relates to a method for assembling a meal kit. The method includes obtaining ingredients for a plurality of food dishes. The ingredients are prepared for each of the food dishes such that the ingredients are in a ready-to-cook/assembly state. The ingredients are placed into a plurality of containers. Each container includes a distinct marking corresponding to one of the food dishes. The containers and an information packet are placed into a transportable medium.

Another aspect of the present disclosure relates to a method for generating a meal planning kit. The method includes providing a plurality of food dish options. Customization options are provided for ingredients of selected food dishes. Food/beverage suggestions based on the selected food dishes are provided. Planning instructions are generated that indicate an order in which each selected food dish is to be prepared such that a total time for preparing all the selected food dishes is minimized.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DRAWINGS

FIG. 1 is a schematic representation of a meal kit having exemplary features of aspects in accordance with the principles of the present disclosure.

FIG. 2 is a schematic representation of a network system suitable for ordering the meal kit of FIG. 1.

FIG. 3 is a schematic representation of a remote device and a host device suitable for use in the network system of FIG. 2.

FIG. 4 is a schematic representation of a database stored on the host device of FIG. 3.

FIG. 5 is a schematic representation of a recipe database store on the database of FIG. 4.

FIG. 6 is a flow chart for a method for ordering the meal kit of FIG. 1 having exemplary features of aspects in accordance with the principles of the present disclosure.

FIG. 7 is a schematic representation of a kit assembly packet having exemplary features of aspects in accordance with the principles of the present disclosure.

FIG. 8 is a schematic representation of exemplary planning instructions from the kit assembly packet of FIG. 7.

FIG. 9 is a representation of a method for assembling the meal kit of FIG. 1 having exemplary features of aspects in accordance with the principles of the present disclosure.

FIG. 10 is a representation of a method for preparing food dishes in the meal kit of FIG. 1.

FIG. 11 is a schematic representation of an exemplary meal planning kit having exemplary features of aspects in accordance with the principles of the present disclosure.

FIG. 12 is a schematic representation of an exemplary meal plan suitable for use in the meal planning kit of FIG. 11.

FIG. 13 is a representation of a method for generating the meal planning kit of FIG. 11.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

Meal preparation requires time to plan, shop for ingredients, and to prepare those ingredients. Due to busy schedules, however, most consumers do not have the required time available to adequately prepare for meals. As a result, consumers tend to rely on unhealthy or expensive alternatives such as dining out or purchasing frozen prepared meals. In this disclosure, a meal preparation system will be described that allows consumers to order meal kits having multiple food dishes with fresh ingredients in a “prepared” state from a remote location. It will be understood that the term “prepared state,” when used to describe ingredients, refers to ingredients that have been prepared for combining with other ingredients to, cooking and/or assembling in a food dish. Such preparation includes but is not limited to cleaning, cutting, chopping, dicing, mincing, mixing, shredding, measuring, etc. Each meal kit is assembled by a meal kit packaging center based on various recipes selected by consumers from a recipe database or on recipes provided by the consumer.

In one embodiment, the meal kit includes a plurality of food dishes (e.g., entrees, side dishes, etc.). Each food dish includes a plurality of containers, which include fresh ingredients that have been prepared for cooking and/or assembling (e.g., chopped, diced, minced, etc.). Each food dish further includes preparation instructions for the consumer on how to cook the ingredients disposed in the containers and planning instructions that provide the order in which each food dish is to be prepared in order to minimize total cooking time. In one embodiment, nutritional information is provided with each food dish. Each container is distinctly labeled in accordance with the preparation instructions.

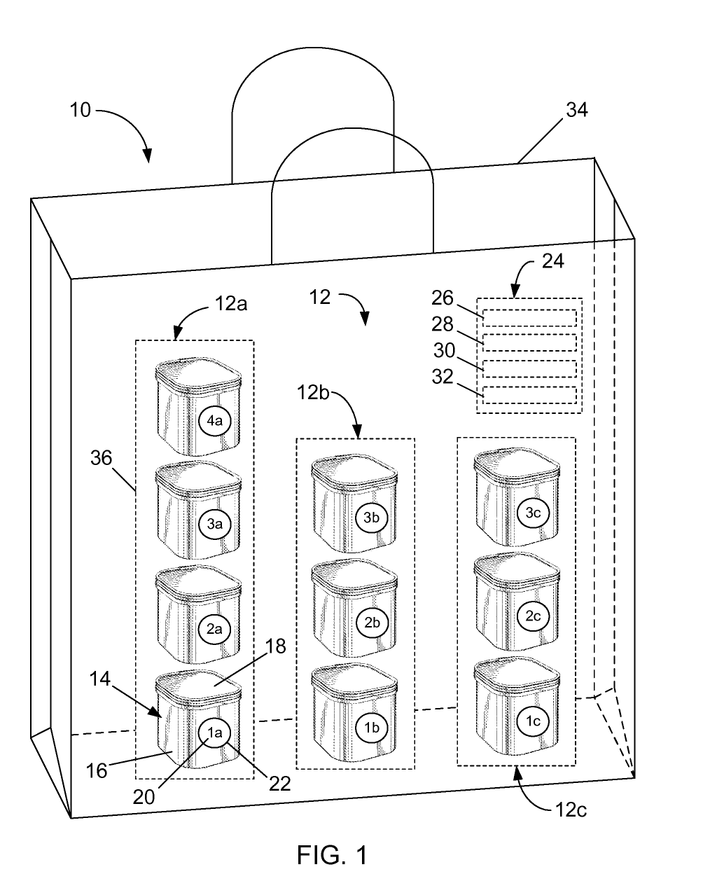

Referring now to FIG. 1, an exemplary meal kit, generally designated 10, will be described. The meal kit 10 includes a plurality of food dishes, generally designated 12. In the depicted embodiment of FIG. 1, and by way of example only, there are three food dishes 12a, 12b, 12c in the meal kit 10. In one example, the first food dish 12a is a starch based food dish 12 such as rice, pasta, potatoes, etc. The second food dish 12b is a meat based food dish 12 such as fish, chicken, etc. while the third food dish 12c is a vegetable based food dish 12 such as asparagus, salad, etc. The food dishes 12 included in the meal kit 10 are selected by the consumer in a manner which will be described in greater detail subsequently.

Each of the food dishes 12 includes a plurality of containers, generally designated 14. In the depicted embodiment, each container 14 includes a body 16 that defines an inner cavity and a cover 18 that cooperates with the body 16 to enclose the inner cavity. In the depicted embodiment, the cover 18 is a removable cover that is in a snap fit engagement with the body 16. It will be understood, however, that the scope of the present disclosure is not limited to the cover 18 being a removable cover that is in snap-fit engagement with the body 16. In another embodiment, the containers 14 can be resealable bags or wrappers.

In one embodiment, the container 14 is a disposable container. In one embodiment, the disposable container is made from a material such as coated paper. In another embodiment, the container 14 is a recyclable container. In another embodiment, the recyclable container is made from a material such as plastic, aluminum, etc. In another embodiment, the container 14 is a compostable container. In another embodiment, the container 14 is a biodegradable container. In another embodiment, the container 14 is a reusable container. In another embodiment, the container 14 is capable of being refrigerated. In another embodiment, the container 14 is insulated for maintaining the temperature within the container 14.

Disposed in each of the containers 14 of the food dish 12 is at least one ingredient for that food dish 12. In the subject embodiment, the ingredients disposed in the containers 14 are in a “prepared” state. It will be understood that the “prepared” state of the ingredients as used in the specification and claims of the present disclosure refers to ingredients that are raw/uncooked or partially cooked but which have been prepared up to the point of cooking and/or assembling. For example, ingredients in the “prepared” state include, but are not limited to, ingredients that have been washed, sliced, diced, measured, etc., so that the ingredients are ready to be cooked or assembled into the food dish 12 by a consumer of the meal kit 10. This “prepared” state of the ingredients can significantly reduce and/or eliminate any preparation time required from the consumer to make the food dish 12.

Each of the containers 14 in the food dish 12 includes a distinct marking 20. In the subject embodiment, the distinct marking 20 is disposed on a label 22 that is affixed to the body 16 of the container 14. In the subject embodiment, and by way of example only, an adhesive affixes the label 22 to the container 14. It will be understood, however, that the scope of the present disclosure is not limited to the distinct marking 20 being disposed on the label 22 or to the container 14 including a label 22 affixed to the body 16 of the container 14.

In the subject embodiment, the distinct marking 20 is alphanumeric. However, it will be understood that the scope of the present disclosure is not limited to the distinct marking 20 being alphanumeric as the distinct marking 20 could include letters, numbers, symbols, colors, etc., or any combinations thereof. In one embodiment, the distinct marking 20 on each of the containers 14 corresponds to an order or step in which the ingredients disposed in the interior cavity of each of the containers 14 are to be prepared (i.e., cooked and/or assembled) by the consumer into the food dish 12. In another embodiment, the distinct marking 20 on each of the containers 14 includes a listing of the ingredients disposed in the container 14.

In the subject embodiment, the meal kit 10 further includes an information packet 24. The information packet 24 includes a set of preparation instructions 26 to be used by the consumer for preparing (i.e., cooking and/or assembling) each of the food dishes 12. The set of preparation instructions 26 refers to each of the containers 14 by the distinct marking 20 disposed on each of the containers 14.

The information packet 24 can further include nutritional information 28 per serving for each food dish 12. In one embodiment, and by way of example only, the nutritional information 28 can include any one or more of the following: serving size, total number of servings, calories per serving, calories from fat per serving, total fat per serving, amount of saturated fat per serving, amount of unsaturated fat per serving, amount of cholesterol per serving, amount of sodium per serving, total carbohydrates per serving, amount of fiber per serving, amount of sugar per serving, amount of protein per serving, amount of vitamin A per serving, amount of vitamin C per serving, amount of Calcium per serving, amount of Iron per serving, and percentages of daily values.

The information packet 24 can further include serving suggestions 30. In one embodiment, the serving suggestions 30 can include information on when to serve the food dish 12. For example, the serving suggestions 30 may indicate that the food dish should be served hot. In another example, the serving suggestions 30 may indicate that the food dish should be allowed to cool for a given time period prior to serving.

In another embodiment, the serving suggestions 30 may provide information on the type or kind of food/beverage that best compliments the food dish 12. For example, the serving suggestions 30 may indicate that a red wine (e.g., merlot, cabernet sauvignon, etc.) best compliments the food dish 12 during the meal or that a particular type of coffee (e.g., light roast, dark roast, etc.) or liqueur best compliments the food dish 12 following the meal. In another embodiment, the serving suggestions 30 may indicate that a salad (e.g., spinach salad, etc.) would be complimentary to the food dish 12. In another embodiment, the serving suggestions 30 may indicate that a type of bread (e.g., a baguette, etc.) would be complimentary to the food dish 12.

The information packet 24 further includes planning instructions 32. In one embodiment, the planning instructions 32 provide information related to the order in which each food dish 12 is to be prepared (i.e., cooked and/or assembled) by the consumer. In one embodiment, the order in which each food dish 12 is to be prepared is based on completing the preparation (i.e., cooking and/or assembling) of each food dish 12 at a similar time as the preparation of the other food dishes 12 are completed. The planning instructions 32 can also provide information on cooking equipment (e.g., pots, pans, spatulas, wooden spoons, etc.) needed by the consumer to prepare (i.e., cook and/or assemble) the food dish 12. In another embodiment, the planning instructions 32 provide information on kitchen equipment settings (e.g., oven temperatures, etc.).

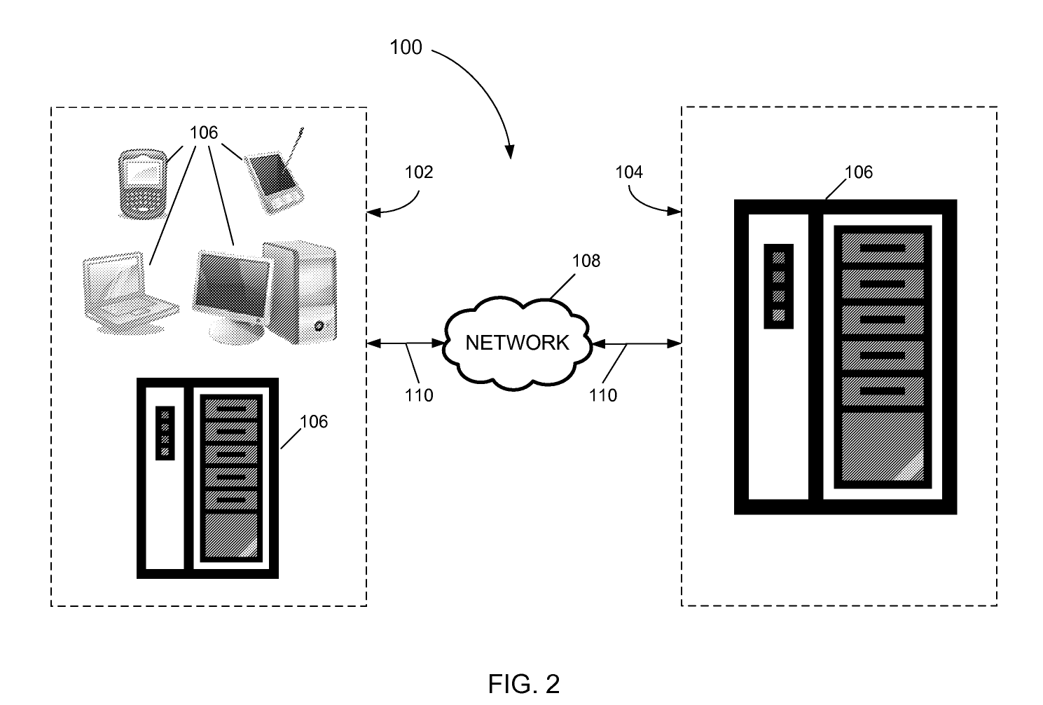

Referring now to FIG. 2, an exemplary network system, generally designated 100, suitable for ordering the meal kit 10 is shown. It will be understood, however, that the scope of the present disclosure is not limited to the use of the network system 100 for ordering meal kits 10 as the meal kits 10 could alternatively be ordered from a store or telephonically.

In the subject embodiment, the network system 100 includes a remote device, generally designated 102, and a host device, generally designated 104. The remote device 102 and the host device 104 can take the form of any of one or more of a plurality of communication devices 106. Such communication devices 106 include, but are not limited to, mobile devices such as cellular phones and personal digital assistants (PDAs) and computer systems such as laptops, desktops, servers, and mainframes.

A communication network 108 provides direct or indirect communication paths 110 between the remote device 102 and the host device 104. In the subject embodiment, the communication network 108 includes, but is not limited to, local area networks, personal area networks, wide area networks, satellite networks, or the Internet. Communications between components in the computing system network 100 can be done through wired or wireless technologies.

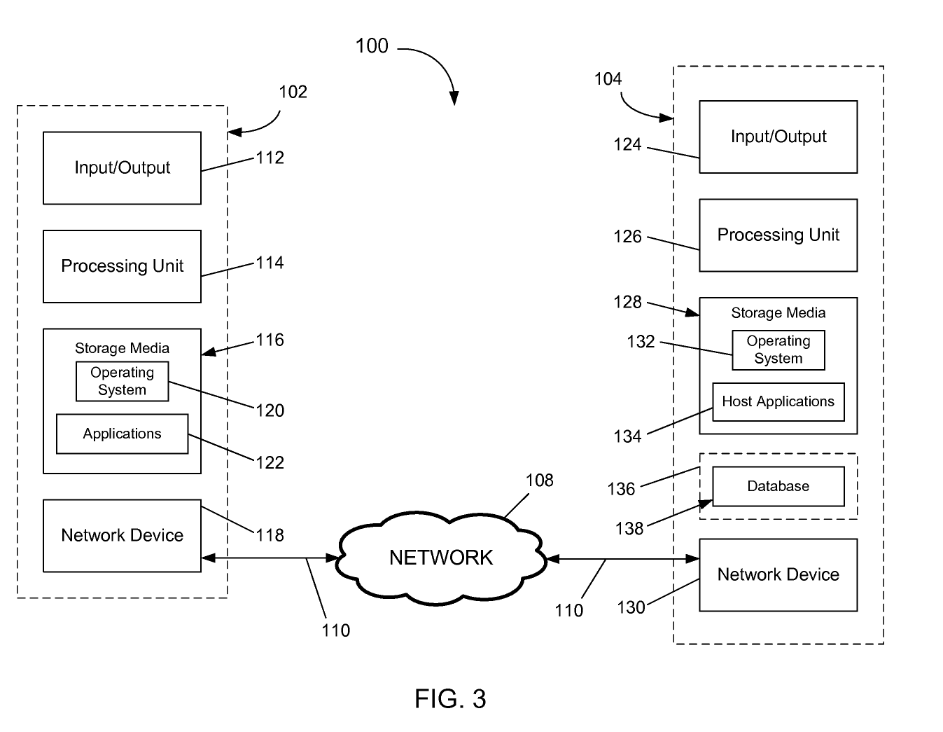

Referring now to FIG. 3, typical elements of the network system 100 are shown schematically. In the subject embodiment, the remote device 102 includes an input/output device 112 (e.g., keyboard, mouse, voice input device, touch input device, display, speakers, printer, etc.), a processing unit 114, storage media, generally designated 116, and a network communications device 118.

The storage media 116 can be volatile memory (e.g., RAM), non-volatile memory (e.g., ROM, flash memory, etc.), or a combination of the two. In the subject embodiment, the storage media 116 includes an operating system 120 and one or more applications 122.

The host device 104 includes a host input/output device 124 (e.g., keyboard, mouse, voice input device, touch input device, display, speakers, printer, etc.), a host processing unit 126, host storage media, generally designated 128, and a host network communications device 130.

The host storage media 128 can be volatile memory (e.g., RAM), non-volatile memory (e.g., ROM, flash memory, etc.), or a combination of the two. In the subject embodiment, the host storage media 128 includes a host operating system 132 and host applications 134.

In the subject embodiment, the host device 104 further includes some form of computer readable media such as a data storage device 136 for storing information. The data storage device 136 can include, but is not limited to, any of one or more of memory storage technology (e.g., RAM, ROM, EEPROM, flash memory, etc.), optical storage technology (e.g., CD-ROM, digital versatile disks (DVD), etc.), or magnetic storage technology (e.g., magnetic cassettes, magnetic tape, magnetic disk storage, etc.).

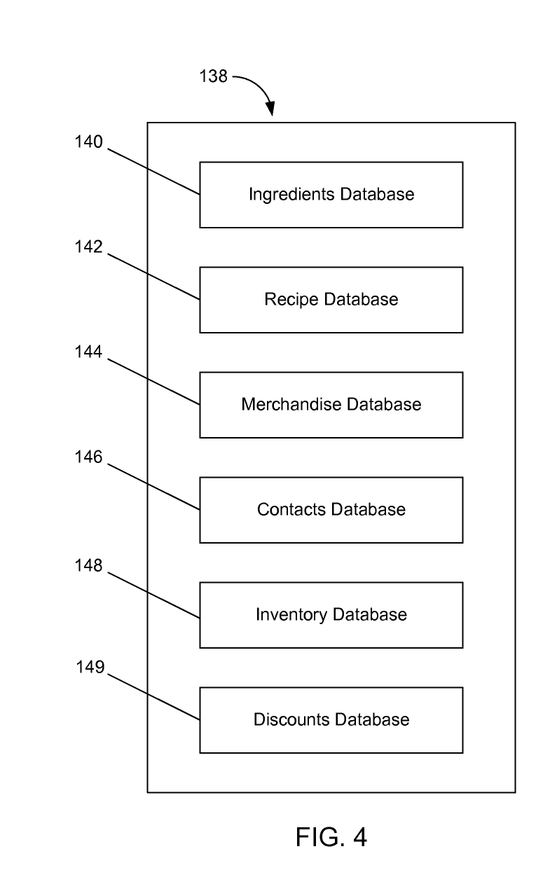

Referring now to FIGS. 3 and 4, a database, generally designated 138, is stored on the data storage device 136. The database 138 is a structured collection of information. In the subject embodiment, the database 138 includes an ingredient database 140, a recipe database 142, a merchandise database 144, a contacts database 146, an inventory database 148 and a discounts database 149.

In the subject embodiment, the ingredients database 140 includes information pertaining to each ingredient. In one embodiment, and by way of example only, this information can include any one or more of the following: an ingredient category (e.g., meat, grain, spice, etc.), a unit of measurement (e.g., ounce, cup, teaspoon, etc.) for the ingredient, a size of a package of the ingredient when purchased wholesale, a cost for the package of the ingredient, number of units of measurement per package, a cost per unit of measurement of the ingredient, total calories per unit of measurement of the ingredient, fat calories per unit of measurement of the ingredient, an amount of total fat per unit of measurement of the ingredient, an amount of saturated fat per unit of measurement of the ingredient, an amount of unsaturated fat per unit of measurement of the ingredient, an amount of cholesterol per unit of measurement of the ingredient, an amount of sodium per unit of measurement of the ingredient, total carbohydrates per unit of measurement of the ingredient, an amount of fiber per unit of measurement of the ingredient, an amount of sugar per unit of measurement of the ingredient, and an amount of protein per unit of measurement of the ingredient.

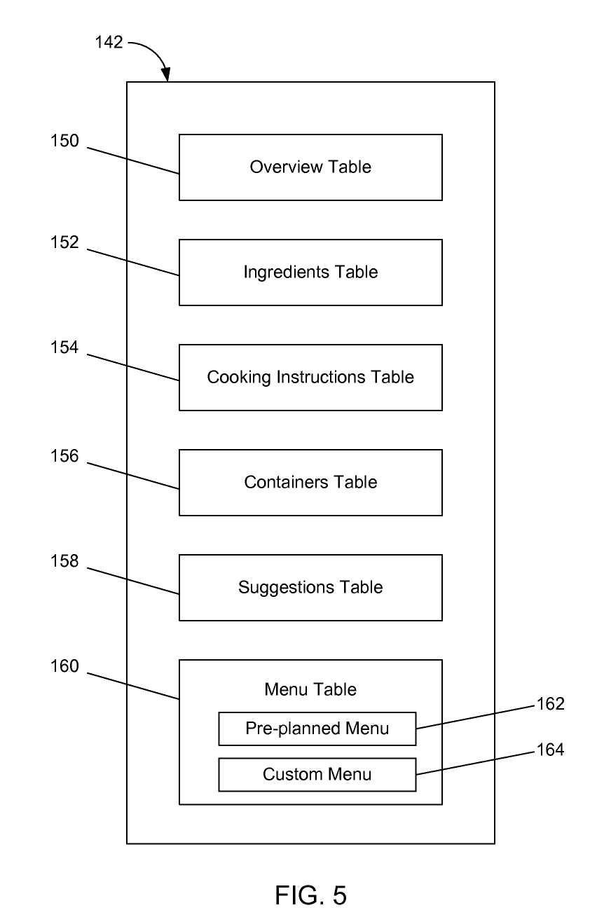

Referring now to FIGS. 4 and 5, an exemplary embodiment of the recipe database 142 is shown. The recipe database 142 includes a plurality of recipes for making food dishes 12. In one embodiment, and by way of example only, each recipe in the recipe database 12 can include any one or more of the following: an overview table 150, an ingredients table 152, an instructions table 154, a containers table 156, a suggestions table 158, and a menu table 160.

The overview table 150 includes general information for a given recipe in the recipe database 142. In one embodiment, and by way of example only, the overview table 150 can include any one or more of the following: a name for the recipe, a course for the recipe (e.g., appetizer, main dish, side dish, etc.), a category for the recipe (e.g., pasta, poultry, etc.), cooking time, an appropriate season for the recipe (e.g., summer, winter, etc.), a number of servings the recipe makes (e.g., 4, 6, 8, etc.), amount per serving (e.g., unit of measurement, etc.), and serving suggestions.

The ingredients table 152 includes information related to ingredients for a given recipe in the recipe database 142. In one embodiment, and by way of example only, the ingredients table 152 can include any one or more of the following: an ingredient listing, an amount of each ingredient, a unit of measure for each ingredient, preparation required for each ingredient (e.g., chopped, sliced, etc.), a listing of ingredients that are optional (e.g., ingredients that may be selectively omitted from the recipe) or adjustable (e.g., ingredients having amounts that may be increased or decreased), the order or step in which the ingredient is cooked or assembled into the food dish 12, and a container designation that identifies the container in which the ingredient is to be packaged.

The instructions table 154 in the recipe database 142 includes information related to preparing (i.e., cooking and/or assembling) each of the food dishes 12. In one embodiment, and by way of example only, the instructions table 154 can include any one or more of the following: step numbers that will correspond with the distinct markings 20 placed on the containers 14 and the order in which the containers 14 are used to prepare (i.e., cook and/or assemble) the food dish 12, a brief description associated with each of the step numbers, a preparation instruction for each of the step numbers, equipment required or recommended to perform each preparation instruction, an estimated total time to complete the steps, and an estimated time to complete each of the steps.

The containers table 156 provides information regarding the size and type of container 14 in which the ingredients for a given recipe in the recipe database 142 can be packaged. In one embodiment, and by way of example only, the containers table 156 can include any one or more of the following: a container designation, type of container (e.g., disposable, plastic, etc.), volume of the container, and container dimensions.

The suggestions table 158 includes information regarding suggested meal compliments for a given recipe in the recipe database 142, as well as information related to the equipment used to prepare the ingredients for a given recipe. In one embodiment, and by way of example only, the suggestions table 158 can include any one or more of the following: a list of suggested meal compliments (e.g., side dishes, wine, coffee, dessert, bread, etc.) and a list of required or recommended equipment to prepare (i.e., cook and/or assemble) the food dish 12.

The menu table 160 includes information regarding food dish 12 combinations (e.g., a main food dish 12 and a side food dish 12, etc.). In one embodiment, the menu table 160 includes a pre-planned menu table 162 and a custom menu table 164. The pre-planned menu table 162 includes a plurality of food dish combinations. For example, the pre-planned menu table 162 can include food dish combinations having a main food dish 12 (i.e., an entrée) and two smaller food dishes 12 (i.e., side dishes). The custom menu table 164 allows for user-defined recipes to be entered in the menu table 160. In one embodiment, and by way of example only, the menu table 160 can include any one or more of the following: estimated time to complete each food dish 12, equipment required for each food dish 12, preparation requirements for each food dish 12 (e.g., preheating oven, etc.)

Referring again to FIG. 4, the merchandise database 144 includes information on equipment (e.g., spatulas, wooden spoons, pots, pans, etc.) recommended for preparing (i.e., cooking and/or assembling) food dishes 12. In one embodiment, and by way of example only, the merchandise database 144 can include any one or more of the following: a product number, a product category (e.g., cookware, tools, etc.), a description of the product, brand names of the product, vendors of the product, vendor numbers for the product, purchasing cost of the product, and a price for selling the product to customers.

The contacts database 146 can include information about any one or more of the following: customers, distribution outlets, suppliers, and production kitchens. In one embodiment, and by way of example only, the customer information includes the customer name, preferred delivery/pick-up location, billing address, contact information (e.g., email address, phone number, etc.), user ID, password, preferred method of payment (e.g., credit card, debit card, etc.), account number for preferred payment method, and expiration date for preferred payment method. In one embodiment, the distribution outlet information includes any one or more of the following: the distribution outlet name, the address of the distribution outlet, information about the primary contact at the distribution outlet (e.g., name, email address, phone number, etc.), days of the week during which deliveries can be made, hours during the day during which deliveries can be made, courier services used to get meal kits 10 to the distribution outlet, and the current status of the distribution outlet (e.g., active, inactive). In one embodiment, the distribution outlet information is provided in a distribution outlets database, which is distinct from the contacts database 146. In one embodiment, the supplier information includes any one or more of the following: the supplier name, the address of the supplier, information about the primary contact at the supplier (e.g., name, email address, phone number, etc.), and the current status of the supplier (e.g., active, inactive). In one embodiment, the production kitchen information includes any one or more of the following: the name of the production kitchen, the production kitchen's address, information about the primary contact at the production kitchen (e.g., name, email address, phone number, etc.), and the current status of the production kitchen (e.g., active, inactive).

The inventory database 148 includes information about ingredients and containers 14 on hand at a meal kit packaging center as well as information about on hand merchandise.

The discounts database 149 can include any one or more of the following: coupon codes, discount amount per coupon code (e.g., $1 off, $5 off, 5% off, etc.), dates during which the coupon code is valid, customers eligible to use the coupon code, number of times coupon code has been used, number of times coupon code has been used by a given customer, food dishes 12 on which coupon code can be used, coupon code restrictions (e.g., not to be used against items from the merchandise database 144, etc.).

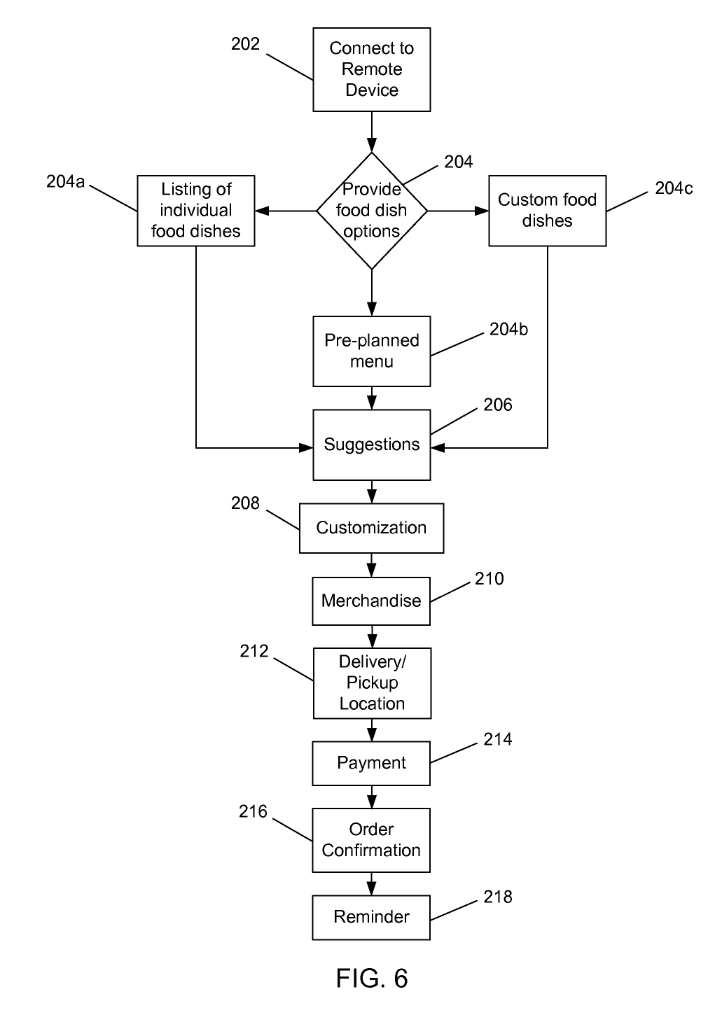

Referring now to FIG. 6, an exemplary method 200 for ordering the meal kit 10 will be described. In step 202, communication between the host device 104 and the remote device 102 is established either directly or indirectly through the communication network 108. In the subject embodiment, the host device 104 and the remote device 102 communicate via the Internet with the remote device 102 communicating with the host device 104 through a host website. It will be understood, however, that the scope of the present disclosure is not limited to the host device 104 and the remote device 102 communicating through the Internet.

In the subject embodiment, after connection with the host device 104 has been established, the remote device 102 logs into the host website using an existing username and password or a newly created username and password. With the remote device 102 logged in, the host device 104 provides food dish choices to the remote device 102 through the host website in step 204. In the subject embodiment, there are three options by which the host device 104 can provide the food dish choices.

A first option 204a uses a listing of individual food dishes 12 provided by the host device 104 through the host website. The listing of food dishes 12 is generated by the host device 104 and provided in accordance with recipes stored in the recipe database 142. In one embodiment, and by way of example only, the food dishes 12 are listed by any one or more of the following: alphabetical, popularity, customer rating, course (e.g., entrée, side dish, etc.), cuisine type (e.g., Italian, French, American, etc.), food type (meat, vegetable, carbohydrate), and main course (e.g., pasta, chicken, etc.). In another embodiment, the host device 104 provides the listing of food dishes 12 based on food dishes 12 that have been previously ordered, including those food dishes which have been previously entered through a third option 204c, which will be described subsequently.

A second option 204b by which the host device 104 can provide the food dish choices uses a plurality of preplanned menus stored in the menu database 158 of the recipe database 142 of the host device 104. In the subject embodiment, the host device 104 provides the remote device 102 with the plurality of preplanned menus, with each preplanned menu having multiple food dishes 12 (e.g., an entrée, a side dish, etc.). In one embodiment, and by way of example only, the preplanned menus are categorized by any one or more of the following: cuisine type (e.g., Italian, French, American, etc.), food type (meat, vegetable, carbohydrate), and main course (e.g., pasta, chicken, etc.). In another embodiment, the host device 104 provides a listing of preplanned menus that have been previously ordered by the remote device 102.

The third option 204c by which the host device 104 can provide the food dish choices uses a user-defined recipe submitted by the remote device 102. In the subject embodiment, the host device 104 receives a consumer-defined recipe for a food dish 12 and stores that consumer-defined recipe in the custom menu table 164 of the recipe database 142. In one embodiment, and by way of example only, the consumer-defined recipe includes any one or more of the following: a name for the recipe, ingredients of the recipe, amount of each ingredient for the recipe, the number of servings made by the recipe, the type of preparation needed for each ingredient (e.g., sliced, diced, chopped, etc.), and the preparation (i.e., cooking and/or assembling) instructions for the recipe. In one embodiment, after the consumer-defined recipe has been entered, the consumer-defined recipe is only available for order by the remote device 102 which entered the recipe. In another embodiment, the consumer-defined recipe is available for order by any remote device 102. In this embodiment, the consumer-defined recipe may contain an indicator supplied by the host device 104 that notifies other consumers whether the consumer-defined recipe has been tested for accuracy and/or taste.

After the food dish 12 or menu has been selected by the remote device 102, this selection is received by the host device 104. In step 206, upon receiving the food dish or menu selection from the remote device 102, the host device 104 provides the remote device 102 with additional food dishes 12 (e.g., entrees, side dishes, etc.) from the menu database 160 or the suggestions database 158 that compliment the selected food dish 12. In one embodiment, the additional food dishes 12 that are provided to the remote device 102 are chosen based on the flavor profile of the selected food dish 12. In another embodiment, the additional food dishes 12 that are provided to the remote device 102 are chosen based on the additional food dishes 12 having similar preparation instructions as the selected food dish 12. For example, additional food dishes 12 having preparation steps that conflict (e.g., different oven temperatures, etc.) with the selected food dish 12 may not be suggested as this would increase preparation time. In another embodiment, the additional food dishes 12 that are provided to the remote device 102 are additional food dishes 12 that have been ordered with the selected food dish 12 by other customers. In another embodiment, the additional food dishes 12 that are provided to the remote device 102 are additional food dishes 12 that have been ordered with the selected food dish 12 by this customer.

The host device 104 may also provide the remote device with other food/drink selections (e.g., bread, dessert, wine, coffee, etc.) from the suggestions database 158 that would compliment the selected menu. The remote device 102 can select additional food dishes 12 from the suggestions provided by the host website or directly from the listing of food dishes 12. In another embodiment, the host device 104 provides the remote device 102 with additional food dishes 12 (e.g., entrees, side dishes, etc.)

In step 208, the host device 104 provides the remote device 102 with a list of customization options for each food dish 12 selected by the remote device 102. For example, in one embodiment, the customization options include the desired number of servings (e.g., 1, 2, 4, 6, etc.) for each of the food dishes 12. In another embodiment, the customization options include ingredient modifications for each of the food dishes 12. The ingredient modifications can include any one or more of additions, deletions, substitutions or quantity adjustments (e.g., increase or decrease an amount of a particular ingredient) to the ingredients of the recipe for each food dish 12. If customization of the food dish 12 is desired, the remote device 102 selects which options to customize and how to customize those options. The host device 104 receives these customizations from the remote device 102.

The host device 104 provides the remote device 102 with a list of equipment needed to prepare (i.e., cook and/or assemble) each of the food dishes 12 chosen by the remote device 102 in step 210. In the subject embodiment, this list of equipment is generated by the host device 104 from information stored in the merchandise database 144. From this list, the remote device 102 can select equipment to purchase. In the subject embodiment, the host device 104 receives the selected equipment from the remote device 102 through the website.

In step 212, the host device 104 prompts the remote device 102 for information related to delivery/pick-up of the meal kit 10. This information can include the delivery/pick-up location and the date of delivery/pick-up. In one embodiment, the delivery/pick-up location can be a store. In another embodiment, the delivery/pick-up location can be the consumer's home. In another embodiment, the delivery/pick-up location can be the consumer's workplace. In another embodiment, the delivery/pick-up location can be a distribution outlet. In the subject embodiment, the host device 104 receives the delivery/pick-up preferences from the remote device 102 through the website.

In step 214, the host device 104 prompts and receives information related to payment from the remote device 102. The host device 104 prompts the remote device 102 for a method of payment (e.g., credit card, debit card, gift card, etc.). In one embodiment, once the method of payment has been selected, the host device 104 prompts the remote device 102 for information related to the method of payment, such as account number, expiration date, name on card, gift card number, etc. In another embodiment, the method of payment is selected from a listing of payment methods that are stored in the contacts database 146 on the host device 104. In another embodiment, the host device 104 prompts the remote device 102 for a coupon code. The host device 104 retrieves information regarding the coupon code entered by the remote device 102 from the discounts database 149 and subtracts any discount from the amount due.

In step 216, the host device 104 sends an order confirmation to the customer. In one example, the order confirmation is sent to the customer via the customer's email address that is stored in the contacts database 146. The order confirmation includes any one or more of the following: order number, payment amount, discounts applied, delivery/pick-up date, delivery/pick-up location, names of food dishes 12 ordered, and any additional products (e.g., merchandise, wine, etc.) ordered by the customer.

In step 218, the host device 104 sends a reminder to the customer. In one example, the reminder is sent to the customer via the customer's email address that is stored in the contacts database 146. In one embodiment, the reminder is sent to the customer on the day the meal kit 10 is to be delivered/picked-up. The reminder includes any one or more of the following: the date on which the meal kit 10 is to be delivered/picked up, the delivery/pick-up location, the order number, names of food dishes 12 ordered, and any additional products (e.g., merchandise, wine, etc.) ordered by the customer.

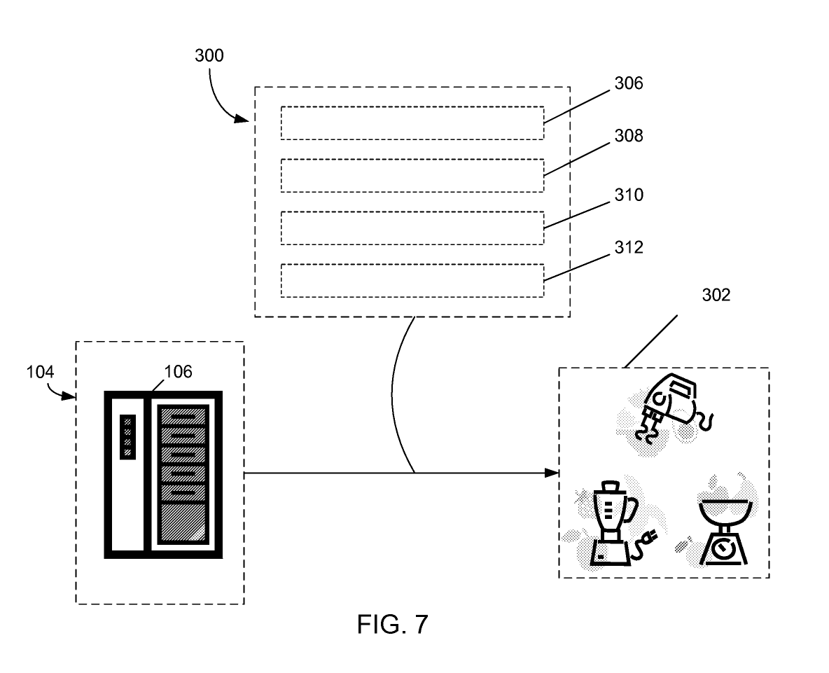

Referring now to FIG. 7, a kit assembly packet, generally designated 300, will be described. In the subject embodiment, the kit assembly packet 300 is transferred from the host device 104 to a meal kit packaging center 302 that packages the meal kit 10 for consumer delivery/pickup. The kit assembly packet 300 provides information related to the packaging of the meal kit 10 to the meal kit packaging center 302. After the host device 104 receives the order for the meal kit 10 from the remote device 102, the host device 104 provides the meal kit packaging center 302 with the kit assembly packet 300. In the subject embodiment, the kit assembly packet 300 is provided to the meal kit packaging center 302 through the Internet. However, it will be understood that the scope of the present disclosure is not limited to the meal kit packaging center 302 receiving the kit assembly packet 300 through the Internet as other types of communication networks may be used. In the depicted embodiment, the kit assembly packet 300 includes a daily order sheet 306, meal kit assembly instructions 308, meal kit packaging information 310, and order information 312.

The daily order sheet 306 is a listing of orders for meal kits 10 received by the host device 104. In one embodiment, the daily order sheet 306 is a listing of orders due in the next 24 hours. It will be understood, however, that the scope of the present disclosure is not limited to the daily order sheet 306 listing orders due in the next 24 hours. In the subject embodiment, and by way of example only, the daily order sheet 306 includes any one or more of the following: a listing of orders by customer, a listing of orders by food dish 12, a listing of ingredients needed to fulfill each order, and preparation (i.e., sliced, chopped, diced, etc.) required for each ingredient.

In one embodiment, the daily order sheet 306 can be used by the meal kit packaging center 302 to order ingredients necessary to fulfill the orders provided on the daily order sheet 306 or to replenish the supply of ingredients. If the daily order sheet 306 provides a listing and amount of ingredients to fulfill orders, this amount can be compared to the amount of ingredients stored in the inventory database 152. Any inventory shortfalls can then be ordered. In another embodiment, the host device 104 can determine the meal kit packaging center 302 that receives an order by comparing the daily order sheet 306 with the inventory database 152. The host device 104 will send the order to the meal kit packaging center 302 that has the required ingredients in stock.

The meal kit assembly information 308 provides information to the meal kit packaging center 302 on how to assembly the meal kit 10. In one embodiment, and by way of example only, the meal kit assembly information 308 includes any one or more of the following: a name for the food dish 12 to be assembled by the meal kit packaging center 302, a number of servings for each food dish 12, a container designation that designates the size of the containers 14 in which to put ingredients for each food dish 12, an order or step designation that will be affixed to the container 14, a listing of ingredients, a unit of measure for each ingredient, and an amount of each ingredient. In one embodiment, the size of the containers 14 is based in part on the ingredients to be contained and the serving size or order quantity specified by the consumer. As previously stated, the order or step designation corresponds to the order or step in which the contents of the containers 14 are prepared (i.e., cooked and/or assembled) in the food dish 12 by the consumer. This order or step designation is referred to in the set of preparation instructions 26, which are part of the information packet 24 of the meal kit 10.

The meal kit packaging information 310 provides packaging materials to the meal kit packaging center 302. In one embodiment, and by way of example only, the meal kit packaging information 310 includes any one or more of the following: the distinct markings 20 for the containers 14 for each food dish 12, the set of preparation instructions 26 for each food dish 12, the nutritional information 28 for each food dish 12, the serving suggestions 30 for each food dish 12, the planning instructions 32 for the meal kit 10, and packaging instructions 400 for the delivery of the meal kit 10.

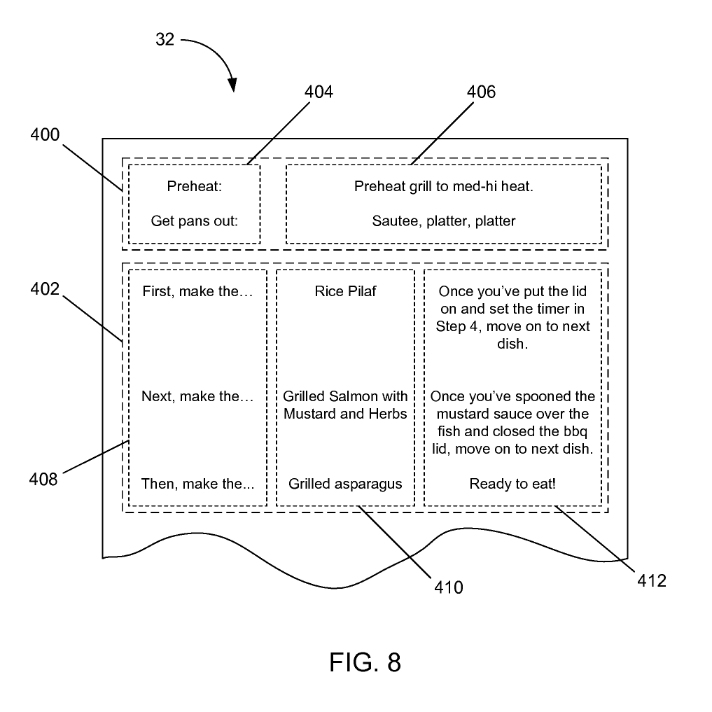

Referring now to FIG. 8, an exemplary embodiment of the planning instructions 32 will be described. In the subject embodiment, and by way of example only, the planning instructions 32 include an equipment preparation section 402 and a preparation order section 404.

The equipment preparation section 402 provides information to the consumer about the preparation required for the equipment to be used for the preparation (i.e., cooking and/or assembling) of the meal kit 10. In the subject embodiment, the equipment preparation section 402 includes a direction section 406 and an equipment section 408. It will be understood, however, that the scope of the present disclosure is not limited to the equipment preparation section 402 having the direction section 406 and the equipment section 408. In the subject embodiment, the direction section 406 includes directions such as “Preheat” and “Get pans out”. The equipment section 408 provides information about equipment needed and appropriate settings of such equipment. For example, in the subject embodiment, the equipment section 408 provides information related to preheating a grill to medium-high heat and to getting out a saute pan and two platters.

The preparation order section 404 provides information to the consumer on how to prepare (i.e., cook and/or assemble) the food dishes 12 in the meal kit 10 such that the preparation (i.e., cooking and/or assembling) of each of the food dishes 12 in the meal kit 10 is completed at a similar time. In the subject embodiment, the preparation order section 404 includes an order section 410, a corresponding food dish section 412, and an instruction section 414. It will be understood, however, that the scope of the present disclosure is not limited to the preparation order section 404 having an order section 410, a corresponding food dish section 412, and an instruction section 414 as any one of these sections could be combined with any other section in the preparation order section 404.

In the subject embodiment, the order section 410 includes the order in which each of the food dishes 12 in the meal kit 10 is to be prepared (i.e., cooked and/or assembled). For example, the order section 410 includes designations such as “first, then, next” to specify the order.

The corresponding food dish section 412 is disposed adjacent to the order section 410 in the cooking order section 404. The corresponding food dish section 412 includes the name of each of the food dishes 12 in the meal kit 10. The name of each of the food dishes 12 is disposed in the corresponding food dish section 412 such that each name is adjacent to the corresponding order in which each of the food dishes 12 is to be prepared (i.e., cooked and/or assembled).

While the preparation instructions 26 provide information on how to prepare (i.e., cook and/or assemble) each of the food dishes 12, the instruction section 414 of the planning instructions 32 provide information on when (i.e., which step in the preparation of one food dish 12) to begin preparation of the next food dish 12. For example, in the depicted embodiment, the preparation (i.e., cooking and/or assembling) of the second food dish 12 is started after a lid is placed on the first food dish 12 and a timer is set.

In one embodiment, after the remote device 102 selects food dishes 12 from the host website and customizes those food dishes 12, the host device 104 determines the amount of time required by the consumer to perform each step in the preparation (i.e., cooking and/or assembling) of each of the food dishes 12 in the meal kit 10. In the subject embodiment, the host device 104 determines this required time based on information stored in the recipe database 142. The host device 104 then generates the planning instructions 32 such that the total time required by the consumer to prepare (i.e., cook and/or assemble) the meal kit 10 is minimized. In one embodiment, the total time required by the consumer to prepare (i.e., cook and/or assemble) the meal kit 10 is less than or equal to about 45 minutes, about 40 minutes, about 35 minutes, or about 30 minutes.

Referring again to FIG. 7, the order information 312 provides data to the meal kit packaging center 302 related to the order placed by the consumer. In the subject embodiment, and by way of example only, the order information 312 includes any one or more of the following: customer name, customer number, date on which the meal kit order was placed, an order number associated with the meal kit order, a delivery/pick-up location, and a delivery/pick-up date and/or time.

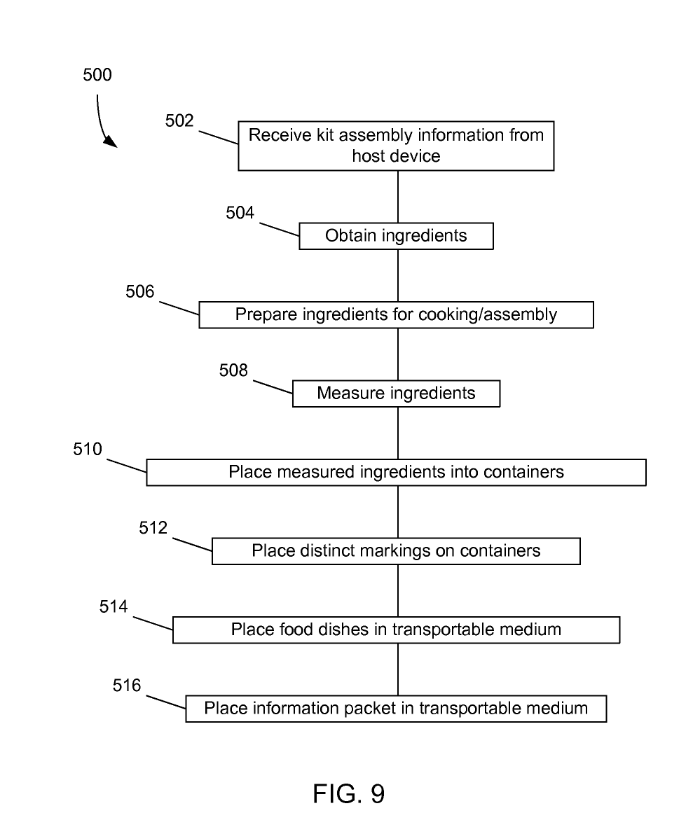

Referring now to FIG. 9, a method 500 for assembling the meal kit at the meal kit packaging center 302 will be described. In step 502, the meal kit packaging center 302 receives the kit assembly information 300 from the host device 104. Once the meal kit packaging center 302 receives the kit assembly information 300 from the host device 104, the ingredients specified on the daily order sheet 306 of the kit assembly information 300 are obtained from storage or from suppliers in step 504. In step 506, the ingredients are prepared for cooking and/or assembling in accordance with daily order sheet 306. For example, the ingredients can be pre-washed, chopped, sliced, etc.

In step 508, the ingredients for a given food dish 12 for the meal kit 10 are measured in accordance with the meal kit assembly information 308. In step 510, the ingredients are placed into the containers 14 specified in the meal kit assembly information 308. In step 512, the distinct markings 20 provided in the meal kit packaging information 310 can be placed onto the containers 14.

With the ingredients for each of the food dishes 12 in the meal kit 10 placed in the appropriate containers 14 as provided in the meal kit assembly information 308, each of the food dishes 12 is placed in a transportable medium 34 (shown in FIG. 1) in accordance with the packaging instructions 400 in step 514. In the subject embodiment, the transportable medium 34 is a bag such as a paper bag or canvas bag. However, the scope of the present disclosure is not limited to the transportable medium 34 being a bag as the transportable medium 34 could also be a portable box such as a cardboard box. In one embodiment, the transportable medium 34 is insulated for retaining the temperature of the food dishes 12. In another embodiment, each of the food dishes 12 is placed in a package 36 (shown in FIG. 1) that is placed in the transportable medium 34.

In step 516, the set of preparation instructions 26 for each food dish 12 and the planning instructions 32 of the information packet 24 are placed in the transportable medium 34. In one embodiment, the set of preparation instructions 26 for each food dish 12 is affixed (e.g., stapled, taped, glued, etc.) to the package 36 containing the food dish 12. In one embodiment, the nutritional information 28 and the serving suggestions 30 are also placed in the transportable medium 34. In another embodiment, information such as customer name, order number, and delivery/pick-up location are affixed to the transportable medium 34.

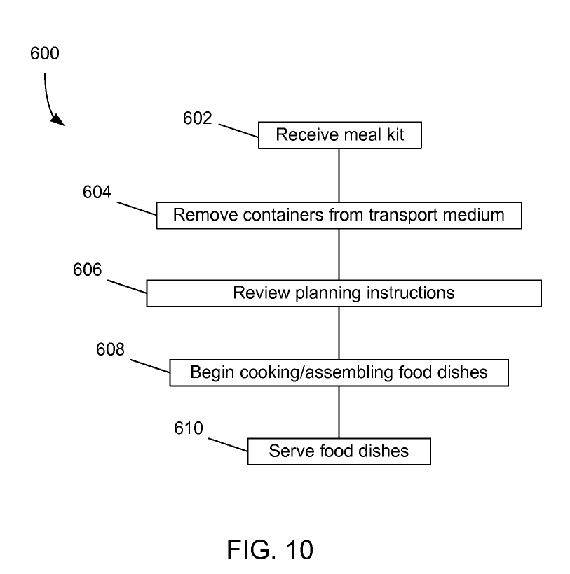

Referring now to FIG. 10, a method 600 for preparing (i.e., cooking and/or assembling) the meal kit 10 will be described. In step 602, the consumer receives the meal kit 10 from a designated pick-up location or a delivery location. In step 604, the consumer removes the containers 14 and the information packet 24 from the transportable medium 34. In step 606, the consumer reviews the planning instructions 32 from the information packet 24. In step 608, the consumer begins preparation (i.e., cooking and/or assembling) the food dishes 12 in accordance with the planning instructions 32 and the preparation instructions 26 for the food dishes 12. As previously described, the preparation instructions 26 for each of the food dishes 12 provide preparation information that is correlated to the distinct markings 20 on each of the containers 14. In one embodiment, the number of containers 14 per food dish 12 is less than or equal to five. As the distinct marking 20 on each of the containers 14 for each of the food dishes 12 corresponds with an order or step in which the container is to be added for preparing the food dish 12, the number of steps needed to complete the preparation (i.e., cooking and/or assembling) of each of the food dishes 12 is less than or equal to ten. In another embodiment, the number of steps needed to complete the preparation of each of the food dishes 12 is less than or equal to five. In another embodiment, the number of steps needed to complete the preparation of each of the food dishes 12 is in the range of one to ten. In another embodiment, the number of containers 14 per food dish 12 is in the range of one to ten. In another embodiment, the number of containers 14 per food dish 12 is in the range of three to five. In another embodiment, as the distinct marking 20 on each of the containers 14 for each of the food dishes 12 corresponds with an order or step in which the container 14 is to be added for preparing the food dish 12, the number of steps needed to complete the preparation of each of the food dishes 12 is equal to the number of containers 14.

Depending on the planning instructions 32, the consumer may have to prepare (i.e., cook and/or assemble) other food dishes while at least one food dish 12 is being prepared. When all of the food dishes 12 have been prepared (i.e., cooked and/or assembled), the food dishes 12 are ready to be served. In step 610, the consumer serves each of the food dishes 12 in accordance with the serving suggestions 30 provided in the information packet 24.

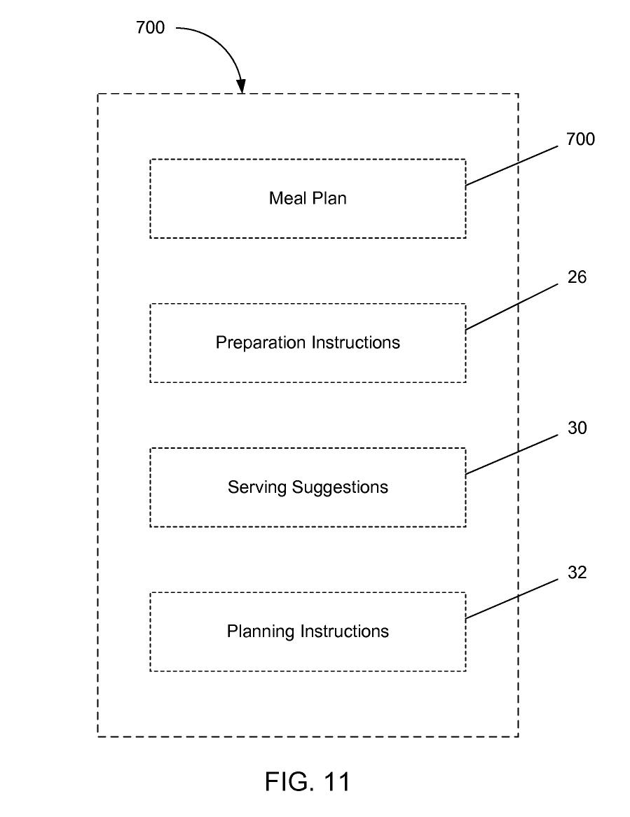

Referring now to FIG. 11, a meal planning kit, generally designated 700, will be described. In one embodiment, the consumer is given an option of obtaining a meal kit 10 or obtaining a meal planning kit 700. The meal planning kit 700 is similar to the meal kit 10 except that the meal planning kit 700 does not include food dishes 12 in containers 14. Rather, the meal planning kit 700 includes a meal plan 702, preparation instructions 26, serving suggestions 30, and planning instructions 32. The meal planning kit 700 requires the consumer to obtain the ingredients for recipes provided in the meal planning kit 700 and to prepare the ingredients in accordance with the recipes provided.

The meal planning kit 700 can include meal plans 702 for a single meal on a given day or can include multiple meals for multiple days. It will be understood that the term “meal” as used herein includes multiple food dishes 12 such as an entrée and two side dishes. In one embodiment, and by way of example only, the meal plan 702 can include any one or more of the following: a description of the various food dishes 12 included in the meal plan 702, the ingredients for each of the food dishes 12 in the meal plan 702, and any equipment necessary to prepare each of the food dishes 12 in the meal plan 702.

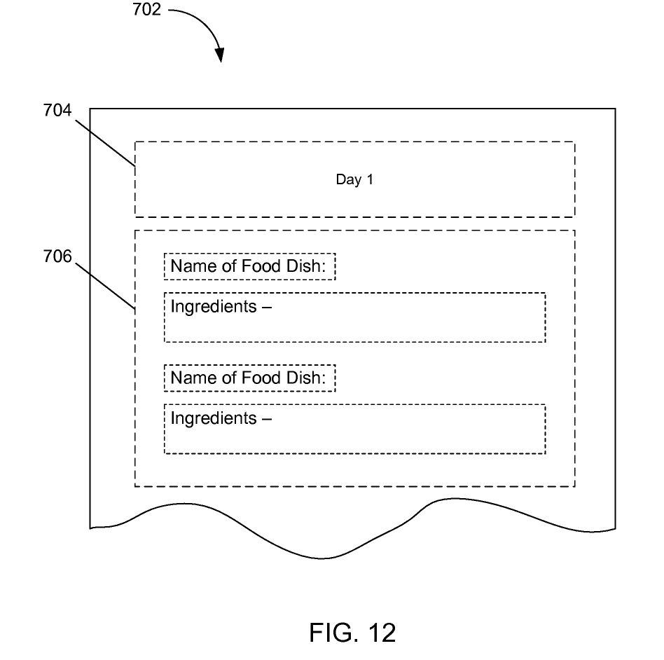

Referring now to FIG. 12, an exemplary embodiment of the meal plan 702 for multiple meals is shown. The meal plan 702 includes a meal-time area 704 and a meal-description area 706. In one embodiment, the meal-time area 704 is populated with a day of the week, such as “Day 1,” “Day 2,” etc. In another embodiment, the day of the week is provided as “Monday,” “Tuesday,” “Wednesday,” etc. In another embodiment, the meal-time area 704 is populated with meals during the day, such as “Breakfast,” “Lunch,” or “Dinner.”

The meal-description area 706 may include the names of each of the food dishes 12 to be prepared at the given meal time and the ingredients required for that food dish 12. For example, under “Day 1,” the meal-description may include an entrée, a first side dish, and a second side dish.

Referring again to FIG. 11, the preparation instructions 32 provide detailed information to the consumer on how to prepare each of the food dishes 12 in the meal plan 702. The serving suggestions 30 provide the consumer with information on complimentary foods/beverages for each of the food dishes 12 in the meal plan 702 while the planning instructions 32 provide information on when (i.e., which step in the preparation of one food dish 12) to begin preparation of the next food dish 12 for a given day/meal.

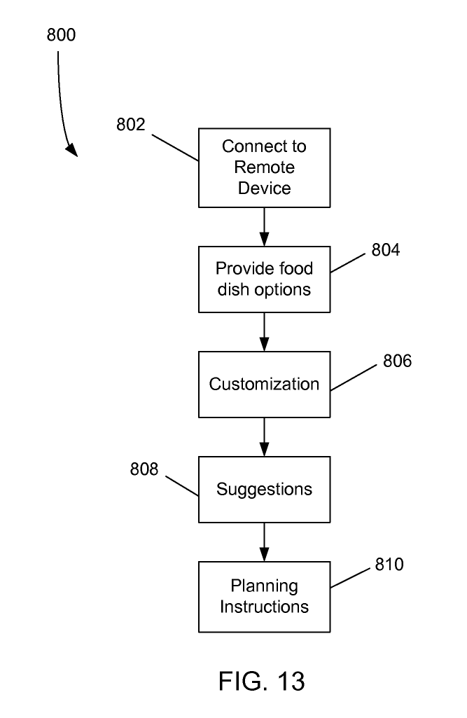

Referring now to FIG. 13, an exemplary method 800 for generating the meal planning kit 700 will be described. In step 802, communication between the host device 104 and the remote device 102 is established either directly or indirectly through the communication network 108. In the subject embodiment, the host device 104 and the remote device 102 communicate via the Internet with the remote device 102 communicating with the host device 104 through a host website.

With communication established between the remote device 102 and the host device 104, the host device 104 provides food dish choices to the remote device 102 through the host website in step 804. In the subject embodiment, the host device 102 can provide a listing of individual food dishes 12 or a listing of preplanned menus.

After the food dish 12 or menu has been selected by the remote device 102, this selection is received by the host device 104. In step 806, the host device 104 provides the remote device 102 with a list of customization options for each food dish 12 selected by the remote device 102. For example, in one embodiment, the customization options include the desired number of servings (e.g., 1, 2, 4, 6, etc.) for each of the food dishes 12. In another embodiment, the customization options include ingredient modifications for each of the food dishes 12. The ingredient modifications can include any one or more of changes in an amount of ingredient added or additions, deletions, substitutions or quantity adjustments (e.g., increase or decrease an amount of a particular ingredient) to the ingredients of the recipe for each food dish 12. If customization of the food dish 12 is desired, the remote device 102 selects which options to customize and how to customize those options. The host device 104 receives these customizations from the remote device 102.

In step 808, the host device 104 generates serving suggestions 30, such as a listing of food/drink selections (e.g., bread, dessert, wine, coffee, etc.) that would compliment the selected food dishes 12 or menu, from the suggestions database 158. In step 810, the host device 104 generates the planning instructions 32 for each meal. In step 812, the meal planning kit 700 is provided to the remote device.

While exemplary embodiments of the meal planning kit 700 and the method 800 for generating the meal planning kit 700 have been described above, it will be understood that the scope of the present disclosure is not limited to the exemplary embodiments of the meal plan 702, the preparation instructions 26, the serving suggestions 30, the planning instructions 32, or to the order of the steps provided in the method 800.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A meal kit comprising:
a plurality of food dishes disposed in a transport medium, each food dish including a plurality of containers having distinct markers associated therewith, wherein the plurality of containers includes a plurality of ingredients in a prepared state; and
a plurality of preparation instructions with each of the plurality of preparation instructions providing for the preparation of one of the plurality of food dishes, wherein each of the plurality of preparation instructions refers to the containers of each food dish by the distinct markers and indicates an order in which each container of each food dish is to be prepared.

2. A meal kit as claimed in claim 1, planning instructions that indicates an order in which each food dish is to be prepared such that a total time for preparing all of the plurality of food dishes in the meal kit is minimized.

3. A meal kit as claimed in claim 2, wherein the planning instructions indicate the order in which each food dish is to be prepared such that the food dishes are completed at a similar time.

4. A meal kit as claimed in claim 2, wherein the planning instructions indicate the order in which each food dish is to be prepared such that the preparation of the plurality of food dishes is completed in less than or equal to about 30 minutes.

5. A meal kit as claimed in claim 1, wherein each food dish includes less than or equal to ten containers.

6. A meal kit as claimed in claim 1, wherein the preparation instructions for each of the plurality food dishes includes less than or equal to ten steps.

7. A meal kit as claimed in claim 1, wherein the preparation instructions for each of the plurality of food dishes includes three to five steps.

8. A meal kit as claimed in claim 1, further comprising nutritional information for each food dish.

9. A meal kit as claimed in claim 1, further comprising serving instructions that provide beverage suggestions to compliment the plurality of food dishes.

10. A meal kit as claimed in claim 1, wherein the containers are selected from a group consisting of disposable containers, recyclable containers, reusable containers, compostable containers, biodegradable containers and combinations thereof.

11. A method for receiving an order for a meal kit, the method comprising:
providing a plurality of food dish options to a remote device, wherein each of the food dish options representing a food dish that must be prepared by a consumer from a plurality of ingredients disposed in containers in a prepared state;
receiving food dish selections from the remote device;
providing additional food dish suggestions to the remote device based on the selected food dish; and
generating a kit assembly packet based on received food dish selections, wherein the kit assembly packet includes preparation instructions for the preparation of the selected food dish, wherein the preparation instructions refer to the containers of the selected food dish by distinct markers disposed on each of the containers and indicate an order in which each container of selected food dish is to be prepared.

12. A method for receiving an order for a meal kit as claimed in claim 11, further comprising providing a listing of cookware needed to complete preparation of the selected food dish, wherein the cookware can be ordered.

13. A method for receiving an order for a meal kit as claimed in claim 11, wherein the plurality of food dish options is provided through a listing of individual food dishes.

14. A method for receiving an order for a meal kit as claimed in claim 11, wherein the plurality of food dish choices is provided through a plurality of pre-planned menus with each pre-planned menu having a plurality of food dishes.

15. A method for receiving an order for a meal kit as claimed in claim 11, wherein the food dish selection is a user-defined recipe entered by the remote device.

16. A method for receiving an order for a meal kit as claimed in claim 11, further comprising the step of providing a listing of ingredient substitutions for a selected food dish.

17. A method for receiving an order for a meal kit as claimed in claim 11, further comprising the step of providing a listing of ingredient deletions for a selected food dish.

18. A method for receiving an order for a meal kit as claimed in claim 11, further comprising the step of transmitting the kit assembly packet to a meal kit packaging center.

19. A method for receiving an order for a meal kit as claimed in claim 11, wherein the kit assembly packet includes planning instructions that indicate an order in which each food dish selected is to be prepared such that a total time for preparing all of the selected food dishes is minimized.

20. A method for assembling a meal kit, the method comprising:
obtaining ingredients for a plurality of food dishes;
preparing the ingredients for each of the food dishes such that the ingredients are in a ready-to-cook/assemble state;
placing the ingredients into a plurality of containers, wherein each container includes a distinct marking corresponding to one of the food dishes; and
placing the containers and an information packet in a transportable medium.

21. A method for assembling a meal kit as claimed in claim 19, wherein the distinct marking on each of the container designates the food dish and an order in which each container is to be prepared in the food dish.

22. A method for assembling a meal kit as claimed in claim 19, wherein the order provided in the planning instructions minimize the total time for preparing all of the food dishes.

23. A method for assembling a meal kit as claimed in claim 19, wherein the information packet includes preparation instructions for each of the food dishes and planning instructions that indicate an order in which each food dish is to be prepared.

24. A method for assembling a meal kit as claimed in claim 22, wherein the information packet includes nutritional information for each food dish and serving suggestions.

25. A method for generating a meal planning kit, the method comprising:
providing a plurality of food dish options to a remote device;
providing a customization option for ingredients of selected food dishes;
providing food/beverage suggestions based on the selected food dishes; and
generating planning instructions that indicate an order in which each selected food dish is to be prepared such that a total time for preparing all the selected food dishes is minimized.
